(19) United States
(12) Patent Application Publication
(10) Pub. No.: US 2011/0207075 A1
(43) Pub. Date: Aug. 25, 2011

(54) Method and Apparatus for Regeneration of Oral Cavity Tissues

(75) Inventors: Gregory B. ALTSHULER, Lincoln, MA (US); Felix I. FELDCHTEIN, Framingham, MA (US)

(73) Assignee: LASER ABRASIVE TECHNOLOGIES, LLC, Quincy, MA (US)

(21) Appl. No.: 13/034,950

(22) Filed: Feb. 25, 2011

Related U.S. Application Data
(63) Continuation of application No. PCT/US2009/054972, filed on Aug. 25, 2009.
(60) Provisional application No. 61/091,522, filed on Aug. 25, 2008.

(51) Int. Cl. A61C 19/00

(52) U.S. Cl. 433/29; 433/215; 433/25

(57) ABSTRACT

A method comprises creating a predetermined pattern of treatment microzones in oral tissue affected by a condition, applying energy of predetermined characteristics to the soft tissue through a tip being limited by at least one dimensional feature of the oral tissue. The application of energy to the oral tissue after creating the predetermined pattern of treatment microzones in the oral soft tissue is terminated. A type of the energy and the characteristics of the predetermined pattern of treatment microzones are defined by the condition in the soft tissue. The condition in the oral tissue can be a gingival recession, gingivitis, periodontal disease, xerostomia, black triangle disease, and interdental/interimplant papilla deficiencies. The oral tissue can be oral soft tissue, such as oral mucosa soft tissue or a gingival soft tissue.

### RELATED APPLICATIONS

This application is a Continuation application of International Application PCT/US2009/054972 filed on Aug. 25, 2009, which in turn claims priority to U.S. Provisional application US 60/091,522 filed on Aug. 25, 2008 entitled, “LASER CONTROLLED REGENERATION OF ORAL CAVITY TISSUES”, both of which are incorporated herein by reference in their entirety.

### FIELD OF THE INVENTION

The subject invention is directed to methods and systems for dental applications. In particular, the subject invention is directed to methods and systems for dental applications implementing oral cavity tissue treatment and oral cavity tissue regeneration required by, but not limited to, periodontal diseases, gingival recession around teeth and implants, deficiencies of interdental and interimplant papilla, dentinal hypersensitivity, restoration of oral bones, conditions of oral glands including xerostomia, conditions of tongue, and the like.

### BACKGROUND OF THE INVENTION

Dental diseases are some of the most widespread problems of human health. Dental conditions, such as, for example, gum conditions play an important role in how people look, and it is part of cosmetic treatment of a smile design.

Thus, periodontal diseases are very prevalent and remain the most common cause of adult tooth loss. In the most common form of the periodontal disease it starts with gingival inflammation (most frequently induced by bacterial infection) and develops as loss of gingival attachment to the tooth, gingival recession, development of tooth mobility and ultimately bone and tooth loss. Development of periodontal disease is initiated by pathogenic bacteria and strongly depends on the host response to these bacteria. The management of periodontal diseases can be divided into two big groups—conservative (non-surgical) and surgical. Conservative management involves deep cleanings known as scaling and root planing (SRP) and curettage. These procedures create an environment with reduced bacterial content where healing can occur. Accompanied with good oral hygiene conservative management these procedures could maintain healthy normal gums. Conservative Periodontal Therapy can involve any of the following methods: oral hygiene instruction and proplylaxis, periodontal scaling and root planing, antibiotic treatment, occlusal equilibration (adjusting the bite). Conservative therapy can be effective at early stages of the periodontal diseases for the aggressive periodontitis, or later stages of the disease, where deep periodontal pockets exist and significant recession or/and bone loss occurred.

Typically, the only effective management of advanced stage of a periodontal disease is periodontal surgery, which could include osseous surgery, gingival grafts, gingival flap procedure, frenectomy, gingivectomy and guided tissue regeneration/bone augmentation, laser therapy for root scaling, pocket sterilization and laser curettage. But even for the surgery the results are not always consistent. Surgical techniques are the only practical choice for the aggressive or advanced disease; however they are expensive, invasive and may have side effects and complications. Therefore a strong need for more conservative, but effective therapeutic techniques still exists.

Gum recession or gingival recession is a big clinical problem affecting a majority of the general population. Gingival recession is defined as the apical migration of the junctional epithelium with exposure of root surfaces. It has been estimated that 50% of the population has 1 or more sites with 1 mm or more of such root exposure. This prevalence rate increases to greater than 88% for individuals who are 65 years or older. Gingival recession puts the patient at risk for root caries and abrasion/erosion of roots due to exposure to the oral environment. Gingival recession has significant negative impact in cosmetic appearance and needs correction as a part of smile design procedure. The patients frequently suffer from dentin hypersensitivity and esthetic discomfort. Multiple techniques were created and are currently used to treat gingival recession, including surgical techniques—Connective Tissue Graft (CTG), Free Gingival Graft (FGG), Guided Tissue Regeneration (GTR) and the Coronally Advanced Flap (CAF). These techniques are usually combined with scaling, root planing and polishing. Surgical techniques can be quite successful, however they are naturally invasive and traumatic, expensive and have the potential for surgery risks and complications such as infection, poor wound healing, etc. Therefore, they are used only for very severe recessions and a less invasive alternative is highly desirable.

Gingival recession around implants is another serious problem reducing the rate of success for such expensive and complex procedure as implant placement and loading. Peri-implant tissues significantly differ from periodontal tissues in terms of lack of cementum and periodontal ligament, less blood vessels and fibroblasts in the connective tissue and absence of an attached supra-crestal connective tissue. Recession around implants can expose the implant abutment or neck. Some controversy exists in the dental literature about the importance of keratinized tissue for the prevention of peri-imlantitis and recession, but many dentists support the opinion that width and thickness of the keratinized tissue around implants is important factor for the prognosis of soft tissue quality around implant and general outcome of the procedure. In particular, different surgical procedures such as CTG, connective tissue pedicle flap (CTPF) or FGG are performed to reconstruct keratinized tissue around implants. There is a need for more conservative soft tissue management procedures improving the width and thickness of the keratinized tissue around implants and reducing the level of peri-implantitis and recession.

Another problem arises from deficiencies of interdental and interimplant papilla in the oral cavity. Interdental papilla is the gingival portion, which occupies the space between two adjacent teeth. Interimplant papilla occupies the space between two adjacent implants. It acts as a biological barrier in protecting the periodontal structures, and also plays a critical role in the aesthetics. The loss of inter-dental papilla can create phonetic problems, food impaction, self consciousness (spiting while talking) as well as cosmetic deficiencies (the black triangles disease). A papillary deficiency could result from surgical excision, traumatic tooth extraction, apically positioned flap and many others. Numerous studies have attempted to determine the condition in which papilla would appear and ways to regenerate it. Although various treatment modalities have been proposed to restore the absent interdental papilla, the predictability and long-term stability of these procedures remain questionable. Therefore, the need exists for a method of growth and regrowth of interdental and interimplant papilla.

Dentinal hypersensitivity is a common condition and generally reported by the patient after experiencing a sharp pain caused by one of several different stimuli. The pain response varies substantially from one person to another. Dentinal hypersensitivity can arise through incorrect tooth brushing, gingival recession, inappropriate diet, and because of other factors. The condition generally involves the facial surfaces of teeth near the cervical aspect and is very common in premolars and canines. The most widely accepted theory of how the pain occurs is Brannstrom's hydrodynamic theory, fluid movement within the dentinal tubules. Therefore, in order to exhibit a response to the stimuli, the tubules would have to be open at the dentin surface as well as the pulpal surface of the tooth. The most important parameter affecting the fluid flow in dentin is the diameter of the tubuli. If the diameter is reduced by one-half, the fluid flow within the tubuli falls to one-sixteenth of its original rate. Consequently, the creation of a smear layer or obliteration of the tubuli can greatly reduce the sensitivity. Management of this condition can be invasive or non-invasive in nature. The most inexpensive and efficacious first line of therapy for most patients is a dentifrice containing a desensitizing active ingredient such as potassium nitrate and/or stannous fluoride. Another group of therapeutic methods include laser irradiation of the dentinal surface, including low power lasers such as He—Ne and GaAlAs lasers and medium power lasers such as Nd:YAG, CO₂ and Er:YAG lasers. The mechanisms of laser reduction of hypersensitivity are not completely understood and discussed in depth in the current dental research literature, but it is known that these mechanisms include desensitization of pulpal receptors, laser induced occlusion or narrowing of dential tubuli, and direct nerve analgesia. Invasive procedures may include gingival surgery, application of resins, or a pulpectomy. As with other conditions, efficacy of non-invasive methods is limited and invasive treatments are not desirable because of pain, discomfort and higher cost associated with them.

Gum disease (periodontal disease) causes alveolar bone loss, and over time can result in tooth loss. It is estimated that 42% of Americans over the age of 65 are toothless (edentulous), and in this growing segment of the population, edentulism reduces the quality of life, impairs nutrition and requires costly treatments. Oral-bone loss and subsequent tooth loss cost an estimated $5-6 billion/year for just the surgical management related to oral-bone loss. If bone damage or loss already occurred due to periodontal disease or trauma, various methods exist for the repair of damaged bone tissue or for the replacement of lost bone. One of the most popular methods of the bone repair and regeneration is known as guided bone regeneration. Since gingival tissue regenerates faster than bone, special measures are needed to separate gingiva and the bone and therefore prevent gingiva from occupying all available space before the bone will grow. A biocompatible membrane is placed between the gingiva and bone which acts as a bather. This bather prevents downgrowth of the gingiva into the underlying bone as it heals. Oftentimes, a bone graft is placed into the underlying bony irregularities, under the membrane, to help the body grow new bone. Membranes around teeth are typically designed to dissolve away, or resorb, after several weeks of healing have passed. Membranes used to restore bony ridges in association with implant therapy are typically non-resorbable, and must be removed at a later date. The known oral bone repair techniques are surgical and thus invasive, therefore a need for more conservative methods providing similar efficacy still exists.

Another condition in the oral cavity is dysfunction of salivary glands, which may be a major reason for insufficient enamel remineralization and other conditions such as xerostomia. Glands located in the mouth secrete fluids to moisten and lubricate the mouth and food and may initiate digestive activity, and that may perform other specialized functions. The most important group is salivary; it includes parotid glands, submandibular glands (submaxillary glands), sublingual glands and multiple minor salivary glands. Insufficient secretion of saliva leads to a condition known as xerostomia, or “dry mouth”. A reduction of saliva may lead to complaints of a dry mouth, oral burning or soreness or a sensation of a loss of or altered taste. Another manifestation may be an increased need to sip or drink water when swallowing, difficulty with swallowing dry foods or an increasing aversion to dry foods. It affects millions of people. Lack of saliva increases susceptibility to infection of the oral cavity and oropharynx and increases probability to develop dental caries.

The general approach to treating patients with hyposalivation and xerostomia is directed at palliative treatment for the relief of symptoms and prevention of oral complications. If the patient's xerostomia is caused by the side effect of a drug, the dentist can recommend an alternative medication, but this course may not be beneficial if the alternate drug has a mode of action similar to that of the original drug. A number of over-the-counter products that can function as saliva substitutes have been developed specifically for patients with xerostomia. Dysfunctionality of salivary glands can have a direct impact to remineralization process of hard tissue and caries prevention. Available in a variety of formulations—including rinses, aerosols, chewing gum and dentifrices—these products also may promote salivary gland secretions. Cholinergic agents stimulate acetylcholine receptors of the major salivary glands. The use of parasympathomimetic drugs such as pilocarpine hydrochloride can stimulate salivary gland secretions and has been shown to be effective for patients with xerostomia. The efficacy of all existing techniques to manage xerostomia is limited and more effective approaches are needed. Other oral glands include Von Ebner, which is influencing gustatory function.

Halitosis (also known as “bad breath”) most often (85% of all cases) is caused by volatile sulfur compound producing bacteria in the oral cavity. Such bacteria exist on the gums, teeth, tonsils, adenoids, and tongue. While other (less common) causes of bad breath also include reflux, sinus infections, pneumonia, bronchitis, kidney failure, metabolic dysfunction, cancer, etc., the most difficult for management cause of halitosis (in people with excellent oral hygiene) is due to bacterial overgrowth in the back part of the tongue. The recommended management techniques include diet modification, and mechanical means like toothbrushing and scraping the tongue. Tongue scrapers or cleaners are slightly more effective than toothbrushes as a means of controlling halitosis in adults, however the effects of tongue cleaning using scrapers or brushes appeared to be very short lived and there was some evidence of tongue trauma which occurred with prolonged use of tongue scraper. Therefore a better technique for the tongue related halitosis management is desirable.

### SUMMARY OF THE INVENTION

In accordance with the subject invention, there are provided methods and systems for dental applications that overcome the above mentioned problems and provide oral cavity tissue treatment and oral cavity tissue regeneration required for patients with aggressive periodontal disease, or required for gingival recession treatment and prevention, interdental/interimplant papillae regrowth, hypersensitivity reduction, gingival thickening for implant placement, bone regeneration for implantology and periodontology, gland functionalty improvement, lingual problem improvement using controlled and localized thermal, mechanical or chemical microdamage to stimulate tissue regrowth and the like.

More specifically, the present invention provides a method comprising the steps of creating a predetermined pattern of treatment microzones in oral soft tissue affected by a condition. The pattern is created by applying energy of predetermined characteristics to the oral soft tissue through a tip being limited by at least one dimensional feature of the oral tissue. Further, the application of energy to the oral soft tissue after creating the predetermined pattern of treatment microzones in the oral soft tissue is terminated. In that method a type of the energy and the characteristics of the predetermined pattern of treatment microzones are defined by the condition in the oral soft tissue and a type oral soft tissue. According to the invention, the referenced energy is optical energy. The condition in the oral soft tissue can be selected from the group consisting of gingival recession, gingivitis, periodontal disease, xerostomia, black triangle disease, and interdental/interimplant papilla deficiencies. The oral soft tissue can be oral mucosa soft tissue or a gingival soft tissue.

Also more specifically, a preventive care method of the present invention is provided comprising the steps of creating a predetermined pattern of treatment microzones in oral soft tissue subjected to the preventive care by applying energy of predetermined characteristics to the oral soft tissue through a tip being limited by at least one dimensional feature of the oral tissue. The method further provides for terminating the application of energy to the oral soft tissue after creating the predetermined pattern of treatment microzones in the oral soft tissue, wherein a type of the energy and the characteristics of the predetermined pattern of treatment microzones are defined by a type of the preventive care and a type of the oral soft tissue. The energy applied to the oral soft tissue can be optical energy. The preventive care to which the oral soft tissue is subjected can be s prevention of gingival recession around tooth or implant, prevention of gingivitis, periodontal disease, xerostomia, black triangle disease, and interdental/interimplant papilla deficiencies. The oral soft tissue can be oral mucosa soft tissue or gingival soft tissue.

The present invention also provides a regeneration method comprising the steps of creating a predetermined pattern of treatment microzones in oral soft tissue subjected to regeneration by applying energy of predetermined characteristics to the oral soft tissue through a tip being limited by at least one dimensional feature of the oral tissue. The method also provides for terminating the application of energy to the oral soft tissue after creating the predetermined pattern of treatment microzones in the oral soft tissue, wherein a type of the energy and the characteristics of the predetermined pattern of treatment microzones are defined by a type of regeneration and a type of the oral soft tissue.

The present invention is also directed to a method comprising the steps of creating a predetermined pattern of treatment microzones in oral hard tissue affected by a condition by applying energy of predetermined characteristics through a tip being limited by at least one dimensional feature of oral soft tissue, to the oral soft tissue and perforating the oral soft tissue. The method also calls for terminating the application of energy to the oral hard tissue after creating the predetermined pattern of treatment microzones in the oral hard tissue, wherein a type of the energy and the characteristics of the predetermined pattern of treatment microzones are defined by the condition in the oral hard tissue and a type of the oral hard tissue.

The present invention is also directed to a method comprising the steps of creating a predetermined pattern of access microchannels to oral hard tissue affected by a condition by applying energy of predetermined characteristics through a tip, the tip being limited by at least one dimensional feature of oral soft tissue, to the oral soft tissue and perforating the oral soft tissue. The method also calls for terminating the application of energy to the oral hard tissue after creating the predetermined pattern of the access microchannels to the oral hard tissue, wherein a type of the energy and the characteristics of the predetermined pattern of access microchannels are defined by the condition in the oral hard tissue and a type of the oral hard tissue.

It is also provided that according to the method of the present invention the oral hard tissue and oral soft tissue can be treated simultaneously.

The present invention also provides for an apparatus for performing the above-described methods comprising a source for generating energy for treatment of an oral tissue; a delivery system for delivering energy to the oral tissue subject to treatment to create a predetermined pattern of treatment microzones in the oral tissue, the delivery system comprising a tip being limited by at least one dimensional feature of the oral tissue. The energy source can be a source of optical energy. The optical source can be a laser, and wherein the laser radiation wavelength is selected from the range of 290 to 1100 nm. The delivery system can be a single beam system. It is provided that the size of the tip serves to create the predetermined pattern by sequentially acting upon the oral tissue through holes disposed in an applicator, the applicator serving to expose a portion of the oral tissue to the energy from the delivery system.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

The accompanying drawings incorporated in and forming a part of the specification, illustrate several aspects of the subject invention and together with the description serve to explain the principles of the subject invention:

FIG. 1 illustrates the concept of periodontal treatment using patterned tissue processing according to the subject invention;

FIG. 2 is a diagram illustrating a single treatment microzone (TMZ) in gingival tissue, made in non-ablative regime (a) or in ablative regime (b) with heating energy sources;

FIG. 3a is a diagram illustrating shapes and patterns of the treatment microzones;

FIG. 3b is another diagram illustrating shapes and patterns of the treatment microzones;

FIG. 4 is an illustration of stimulation of bone growth using a matrix of ablative columns in the gingiva around the bone;

FIG. 5 is a schematic diagram of an apparatus for dental applications according to one embodiment of the subject invention;

FIG. 6 is a schematic diagram of an apparatus for dental applications according to another embodiment of the subject invention;

FIG. 7 is a schematic diagram of an apparatus for dental applications according to another embodiment of the subject invention;

FIG. 8 is a schematic diagram of an apparatus for dental applications according to another embodiment of the subject invention;

FIG. 9 an illustration of stimulation of a sublingual salivary gland for treatment of xerostomia using a pattern of TMZ made through the oral mucosa covering the gland;

FIG. 10 is a schematic illustration of management of periodontal disease and possible geometry of the TMZ

FIG. 11 is a schematic illustration of enhancement of a soft tissue around an implant to prevent or stop recession

FIG. 12 is a schematic illustration of treatment of interdental papilla to reduce black triangles

FIG. 13 is a schematic illustration of frontal view of a TMZ pattern for periodontal pocket management FIG. 14 is a schematic diagram of an apparatus for dental treatment.

FIG. 15 is a schematic diagram of an apparatus for dental applications according to another embodiment of the subject invention where apparatus produces TMZ patterns integrated with dental camera.

FIG. 16 is a schematic diagram of an apparatus for dental applications according to another embodiment of the subject invention with applicator adopted to the shape of treatment area of oral cavity as arc of the gum (figure a) or periodontal area of a tooth (figure b).

FIG. 17 is a schematic representation of an applicator with holes masking the tissue.

### DETAILED DESCRIPTION OF THE PREFERRED EMBODIMENTS

The subject invention is directed to use of a laser in methods and systems for dental applications, and, more specifically, the subject invention is directed to use of a laser for methods and systems implementing oral cavity tissue treatment and oral cavity tissue regeneration called for by, but not limited to, periodontal diseases, gingival recession around teeth and implants, deficiencies of interdental and interimplant papilla, dentinal hypersensitivity, restoration of oral bones, conditions of oral glands including xerostomia, conditions of tongue, and the like.

The present invention relates to a new family of methods for implementation of a laser for management and prophylaxis of dental diseases and apparatus for such management, based on stimulation of oral tissue growth during a healing process as a response of a living body to controlled oral tissue treatment. According to the invention, the oral tissue treatment is pattern controlled and is capable of being performed by thermal, mechanical or chemical means. Thermal treatment may be induced by electromagnetic radiation including optical and microwave radiations, direct application of heat, electrical current (AC or DC) including radiofrequency energy application, mechanical energy and ultrasound. Chemical controlled treatment of oral tissue is capable of being performed by direct patterned application of chemicals, or may result from introducing a chemical into the bulk of the oral tissue to be processed, followed by application of light in a predetermined pattern, activating the chemical, inducing localized phototoxicity and creating a patterned photodynamic therapy.

Patterned Treatment Microzones

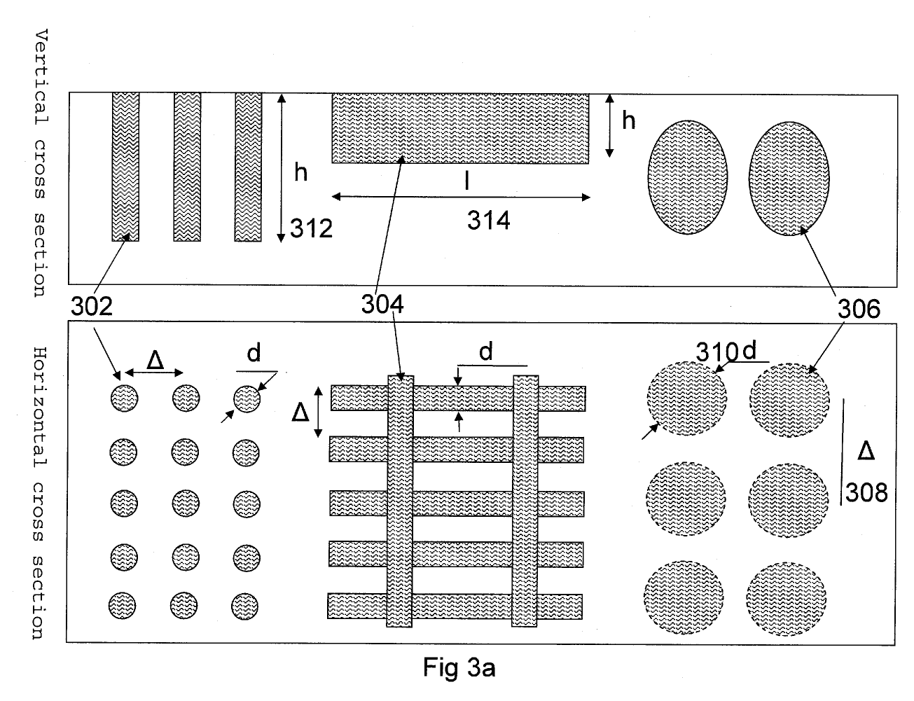

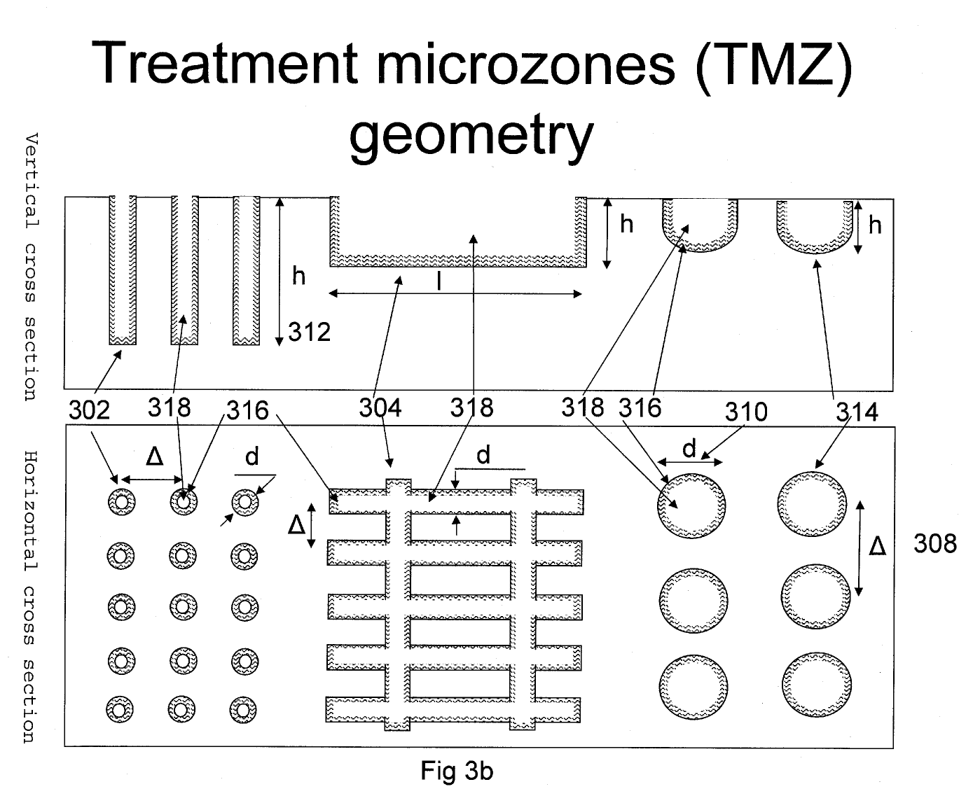

Turning now to FIGS. 3a and 3b, treatment microzones (TMZ) 302, 304, 306, 310 may be of different shapes, such as a cylinder (302), a rectangle (304), an oval (306), a sphere, semisphere and the like. It is important that the minimal size d (310) of TMZ be small for better interaction with the surrounding untreated tissue for faster healing without complications and scarring if TMZ contains a tissue treatment zone. A typical minimal size of TMZ is usually in the range from one cell (several nm) to one mm The preferable range is from 30 nm to 500 nm. The depth h (312) of TMZ can be in the range from d to 10 mm and can be deep enough to penetrate into several types of oral tissue and organs. For example, TMZ can penetrate through a gum, cementum and dentine, or penetrate through mucosa to a gland.

TMZs shown in FIG. 3a may be created by hyperthermia, hypothermia, laser or other energy induced coagulation, chemical reaction, or photochemical reaction, such as photodynamic therapy. TMZs shown in FIG. 3b may result from tissue ablation with formation microcavity 318 in the tissue or without a coagulated layer 316. TMZ as the microcavity 318 in the tissue may also result from mechanical or thermomechanical treatment with a hot tip.

Patterns of isolated TMZ may be periodical (as shown on FIGS. 3a, 3b), or random. In a periodical pattern the period Δ (308) is equal or larger than d. The fill factor F is defined as a ratio of the volume or surface area of TMZs to the volume or surface area of the treated oral tissue. The fill factor may vary in the range from 0.1% to about 70%, preferably from 1% to 30%.

Energy Sources.

Patterned treatment may be performed using different energy sources in order to provide a treatment effect in and around the treatment microzones (TMZ). The treatment effect can be achieved by oral tissue heating, cooling, mechanical pressure, ultrasound and chemical reaction. Oral tissue heating may produce therapeutic effects by increasing oral tissue metabolism (below the temperature of irreversible oral tissue damage), heat shock proteins production, cell apoptosis, cellular damage due to enzyme inhibition, stimulating growth of new tissue including collagen, vessels coagulation. Oral tissue heating is capable of being provided by following energy sources: electromagnetic radiation including light and microwave, hot tip by thermal conduction, electrical current including DC and AC, ultrasonic energy.

A general view of an apparatus for treatment of oral tissue 1400 with patterned TMZ 1402 is shown on FIG. 14. The apparatus comprises a microtip 1404 incorporated in dental handpiece 1406, which in turn is connected to a main unit 1410 via umbilical 1408. A treatment energy source is completely or partially packed into the main unit. The energy is delivered into handpiece and then through the handpiece to the microtip. The microtip produces TMZ 1402 on jaw 1400. Energy sources can be a diode or other laser located in main unit 1410 which delivers energy through an optical fiber in umbilical 1408 to optical or hot microtip 1404. In another embodiment a solid state laser pumped by diode laser can be located in hand piece 1406. In another embodiment an electrical energy sources can be located in main unit 1410, delivering energy through umbilical 1408 to a pin microtip in handpiece 1406. Patterned geometry of TMZ 1402 in this embodiment would be controlled by an operator by properly locating the microtip on the treatment tissue.

In particular, the present invention utilizes a concept of laser patterned thermal treatment to promote regeneration of oral tissues, such as gingiva, oral mucosa, cementum, dentine and bones and to manage a number of conditions in the oral cavity. Oral tissues, in particular, oral mucosa and gingiva, are known to have very strong regeneration potential, much better than that of the skin, in which efficient skin rejuvenation has been demonstrated as a response to laser skin resurfacing, mechanical and chemical peeling. Therefore, creation of a treatment pattern and appropriate tissue response induces tissue regeneration, rejuvenation, generation of new fibrotic tissue and potentially thickness of volume increase (I don't understand the meaning of this). According to the subject invention, these processes are utilized to manage oral conditions, such as a gingival recession and others. Additionally, the referenced tissue healing response includes creation of large amounts of fibroblasts, which are known to be instrumental in periodontal attachment process. For that reason the laser is used herein in the form of patterned treatment is used herein to promote periodontal attachment.

Gingival recession is a condition where such laser-based treatment could become a successful minimally invasive alternative for a surgery. We suggest initiating gingival regeneration and growth by creating a laser radiation-induced pattern of treatment microzones in the gingiva. Each zone may be a column, sphere, semisphere, line, rectangular or another shape of ablation or coagulation with a depth ranging from 0.05 to 2 mm, diameter or width from 0.005 to 1 mm and having a fill factor from 1% to 75% per one treatment. The fill factor is defined as a ratio between the areas occupied by the zones to the total treatment area Such treatment microzones can be created by a broad range of lasers and wavelengths, including ultraviolet, visible, near infrared, mid infrared or far infrared ranges. In particular, diode lasers operating in the range of 800-2300 nm, Nd:YAG, Er laser a with wavelength in the range of 2600-3000 nm and other lasers currently known in microsurgery may be successfully used to create such zones.

In a preferred embodiment, a diode laser having a wavelength from 800 nm to 2100 nm and power from 1 W to 100 W operating in contact regime may be used. It may use a silica or sapphire microtip with a diameter from 0.1 to 1 mm. The pressure applied by the tip to the oral tissue enhances penetration of light into the tissue, as well as the coagulation column depth, partially because of the changing blood content in the tissue under the tip. Alternatively, an Er-doped laser may be used in a contact or a non-contact mode, operating in the 1500 nm or 3000 nm spectral range, with similar tips. In the non-contact mode an appropriate spacer may be used to maintain the distance between the tissue and the focusing optics. The exposure time to create each column may vary from 1 nsec to 1 sec. Preferably, the exposure time should not exceed approximately tenfold of the thermal relaxation time for the entire column, and, therefore, the preferred exposure time may be between 1 and 300 msec.

Multiple factors should be taken into account to select optimal laser wavelength and treatment regimes. One possibility is the choice between the ablative and non-ablative treatment. The non-ablative treatment is less invasive, more sparing, and is preferable if the desired clinical effect can be reached. The ablative treatment, or thermomechanical treatment with creation of microcavity, is more aggressive and invasive, it can produce a more significant treatment outcome.

Destruction of the epithelial/connective tissue barrier in the course of the ablative treatment increases the chances of wound contamination and potential complications. At the same time, the release of growth factors (in particular, TGF-α) by epithelial cells have been shown to play a crucial role in the wound healing process and, therefore, in the final tissue recovery. This process normally does not occur if the epithelium is intact. For the ablative treatment, a strong linear or nonlinear absorption in the oral tissue of as high as 1000-10000 cm⁻¹ is required. Nonlinear (two and multiphoton) absorption requires very high intensities, which can only be created using relatively complex and expensive picosecond and femtosecond lasers. Also, safety data concerning intensive ultrashort pulse laser radiation are not well defined. For these reasons, one of the preferred spectral ranges includes laser wavelengths with strong linear absorption in water, which is a primary chromophore in oral soft tissue. In particular, solid state lasers using Er:YLF, ER:YAG and Er:YSGG crystals are known to operate at several wavelengths in the 3000 nm area. The water absorption at these wavelengths varies from ˜500 cm⁻¹ and to ˜10,000 cm⁻¹ respectively, which will allow achieving very different zones of lateral coagulation around the ablation crater. Radiation with higher absorption cannot penetrate deep in the oral tissue and will create a smaller coagulation zone. Water absorption at within 3000 nm area could be similar to the CO₂ laser radiation and is expected to have similar effect on tissue. However, solid state lasers have significant ergonomic and cost advantages over CO₂ lasers.

For non-ablative treatment, use of endogenous chromophores may be considered, or use of water as the absorbing substance universally present in oral soft tissues. It is important that a TMZ should penetrate the epithelium and create some controlled treatment within the underlying connective tissue. Gingiva usually has an epithelium thickness from 0.2 to 0.5 mm; therefore, the minimal practical depth for the TMZ should be at least 0.7 mm. The linear absorption coefficient may be in the range of 0.5 to 25 cm⁻¹ for non-ablative modalities to create appropriate columns of thermal injury. A 960-980 nm wavelength laser is considered a good candidate for the treatment using water and blood components as the chromophores. Other wavelengths with relatively high (1470 nm, 25 cm⁻¹) and relatively low (1550 nm, 10 cm⁻¹) absorption in the water may also be used for the described patterned treatment.

The natural ability of oral tissue to regenerate may be enhanced by introducing cell cultures, such as stem cells, or by introducing chemicals known as growth factors. Growth factors are signaling molecules that stimulate or inhibit proliferation, migration, and differentiation, depending on the cell type. Another factor strongly influencing the oral tissue repair and regeneration after treatment is an extracellular matrix (ECM). ECM is a complex mixture of structural and functional proteins, glycoproteins, and proteoglycans arranged in a unique, tissue specific three-dimensional ultrastructure. The ECM exists in all tissues and organs but may be harvested for use as a therapeutic scaffold from external sources. Some materials are commercially available and Food and Drug Administration (FDA) approved, such as Millipore® filter (HA) with a teflon membrane (Biopore®; BO) and a teflon-based periodontal material (Gore-Tex®; GT).

Parameters of Light Energy Sources.

1. Wavelength.

a. Soft tissue treatment. Two primary tissue chromophores may be used: blood and water. For blood absorption, the wavelength from 290 to 1100 nm may be used, preferably from 390 to 600 nm and, most preferably, from 480 to 600 nm, from 390 to 450 nm and from 900 to 1100 nm. For water as a chromophore, the wavelength from 900 to 11,000 nm may be used, preferably from 900 to 2600 nm and from 3500 to 5900 nm for coagulative treatment, and from 2600-11,000 for ablative treatment.

b. Hard tissue treatment for bone, cementum, cartilage and dentine. Two primary chromophores may be used: water and apatite. Accordingly, the wavelength range for coagulative treatment can be from 900 to 2600 nm and from 3500 to 5900 nm, and for ablative treatment—1900-11,000 nm with the preferable range 2700-3000 nm.

2. Pulsewidth.

a. For optimal creation of a coagulate microscopic treatment zone, the pulsewidth is preferably shorter than about 10×TRT (thermal relaxation time) of the microscopic treatment zone. The microscopic treatment zone size is from about 1 μm to about 1 mm, wherein TRT is from about 11 s to about 1 s. Therefore the pulsewidth is preferably in the range from fs to about 10 s.

b. For optimal creation of an ablative microscopic treatment zone, the pulsewidth is preferably shorter than TRT (thermal relaxation time) of the microscopic treatment zone. The microscopic treatment zone size is from about 1 μm to about 1 mm and the TRT is from about 1 μs to about 1 s. The pulsewidth is in the range 1 fs to about 1 s, the preferable range is 1 μs to about 1 s.

c. Patterned treatment may be performed with a continuous wave (CW) or quasi CW pulsed energy sources by scanning a beam or tip delivering energy across the oral tissue which is subjected to treatment. The effective pulsewidth in this case is determined as τ_{eff}=W/v, where W is the size of the beam or tip in contact with the oral tissue and v is the speed of scanning. In this case, τ_{eff} for a coagulative microscopic treatment zone is preferably shorter than 10 TRT, and for an ablative microscopic treatment zone it is preferably shorter than TRT. With linear heat diffusion in the tissue the TRT=W²/8α, where α is a coefficient of thermal diffusion of the tissue. The speed of scanning is preferably v>0.8α/W and v>8α/W for coagulated and ablated treatment microzones, respectively. For the typical soft tissue treatment parameters it means v>1 mm/s and v>10 mm/s for coagulated and ablated microzones, respectively.

d. Energy per a microscopic treatment zone depends on the size of the TMZ, wavelength and pulsewidth. It is preferably in the range from about 1 μJ to about 10 J. The preferable fluence range is from about 0.01 J/cm² to about 1 kJ/cm².

Light Energy Sources with Wavelengths from 290 nm to 11,000 nm.

Diode lasers based on different active medium, such as GaN, InGaN, GaP, can be used for a visible range, laser based on GaAs, GaAsAl can be used for a near infrared range (700-1200 nm), lasers based on InP, InGaAsP/InP can be used for a range of 1200-2000 nm, and lasers based on GaSb can be used for a range of 2000-3100 nm. Diode lasers can be used as individual emitters or the can be combined in laser bars. Diode laser power can be coupled into an optical fiber. A diode laser can be packaged as a vertical-external-cavity surface-emitting-laser (VECSEL), also known as a vertical cavity surface-emitting-laser (VCSEL). A VCSEL-type device can be also used as an individual emitter or in arrays. A quantum cascade diode laser can be used for wavelengths longer than 3000 nm.

High brightness radiation is produced by a solid state laser with diode pumping or flash lamp pumping. Different active ions, such as Cr, Tm, Nd, Yt, Ho, Er, Ti, in different host materials can be used as glass, single crystals, ceramics. The most popular crystal host materials are YAG, YLF, YSSG and others.

Fiber laser baser quarts fibers doped by Nd, Yt, Er or Tu are known to produce high power radiation in the range of 900-2000 nm with an optional Raman convertor or an IR fiber doped by Er, Ho, Tm, Cr.

Gas lasers, such as CO₂ lasers, generate wavelengths from 9300 nm to 10600 nm.

Another useful class of light sources is a class of light emitting diodes (LED) with wavelengths from 290 to 2000 nm LEDs are similar to diode lasers and can be packaged in a 1D or 2D array with optical image transfer of the array onto the treatment area. In this case every individual LED or a diode laser emitter is capable of providing a single microscopic treatment zone (TMZ).

Patterns of TMZ can be generated using interference, diffraction or speckle light distribution from all light sources listed above.

Microwave Electromagnetic Energy Sources.

Microwave energy with the wavelength close to 1 mm (300 GHz) can be used to form heat-produced TMZ. The pulse width and energy parameters can be close to those of the light energy sources.

Hot Tip.

A hot tip or an array of hot tips can be used to form TMZ. For example a hot tip may be implemented as a metal needle with a diameter 0.1-1 mm heated by an electrical current to a temperature higher than some threshold of a therapeutic effect—typically higher than 45° C. and preferably higher than 60° C. The hot tip can be built as an optical waveguide, or it can include a fiber with a diameter 0.1-1 mm with an absorbing material at the distal end (activated optical tip). In such a case the tip will be heated by light energy. A bundle of optical tips with a predetermined spacing between the fibers can also be used. The wavelength of light that generates the heat should be absorbed by the absorbing material at the distal end. Optical hot tips or an array of them can be used in a combo mode when the heating effect is partially achieved by heat conduction from the hot tip heated by light and partially by the light penetrating into the oral tissue and absorbed in it. The hot tip can produce TMZ as shown in FIG. 3b where microcavity 308 created by mechanical perforation is shown surrounded by coagulated tissue. Such TMZ is a similar to laser ablative TMZ, but need low energy to remove the issue. TMZ patterned on hard tissue, such as cementum, bone, cartilage or dentine, can be created mechanically using a sharp tip or a microbur. (bur is a cutting/drilling tool).

Electrical Current, Such as DC and AC and Radiofrequency.

TMZ can be performed by heating the tissue by an electrical current in the area of coupling the electrical current into the tissue. A single microelectrode or an array of microelectrodes can be used for this purpose. The electrodes in the area of their contact with tissue can have different shapes, such as circular or linearly elongated, to produce TMZ as shown in FIG. 3. The size of microelectrodes in the contact area in their smallest dimensions can be from about 1 μm to about 1 mm Microelectrodes can be made as conductive pins for a DC or AC current, or as capacitors for a radiofrequency current (1-100 MHz). Electrical current may run directly between microelectrodes, or between the microelectrode or their array, and a patch electrode with a coupling area much larger than the coupling area of the microelectrodes and their s array. The pulsewidth of the electrical current can be comparable or shorter than the thermal relaxation time of the smallest size of TMZ. For the 1 μs to 1 mm TMZ size, the thermal relaxation time is in the range of about 1 μs to about 10 sec.

Ultrasound.

TMZ can be created by the ultrasound energy by way of cavitation at frequencies from 0.02 to 1 MHz or by way of heating at frequencies from 1 to 100 MHz or their combination. Patterned TMZ can be created by focused ultrasound or by a phased synchronized array of transducers. A focused shock wave generator can be used to form TMZ in hard tissues, such as bone, cement or dentine.

TMZ can be produced chemically or photochemically. For example, a chemical agent with a low pH (pH<2) can be applied to the soft tissue through an acid-inert mask (Teflon® is an example of such material) with a pattern of small (0.05-1 mm) holes for a predetermined time. Pattern of TMZ as shown in FIG. 3a can be created in soft tissue as a result of denaturation of chemical proteins. A pattern of microcavities in the hard tissue can be formed as a result of acid dissolution of the hard tissue.

Patterned treatment can be enhanced with applied pressure to the treated tissue, as well as with cooling and with shock waves. For example, applying pressure to the optical or the hot tip can increase the depth of TMZ. Cooling of the tissue can decrease the damage effect on epithelium without changing the level of damage for the underlying connective tissue. Further, after the creation of the pattern of treatment microzones, the regeneration can be enhanced by low level light radiation, which is known to promote wound healing and stimulate soft and hard tissues growth In particular, visible and near infrared light can be used for this purpose. Ultrasound radiation and shock wave therapy may be also used for promoting wound healing and stimulation of soft and hard tissue regeneration and growth.

Periodontal Regeneration

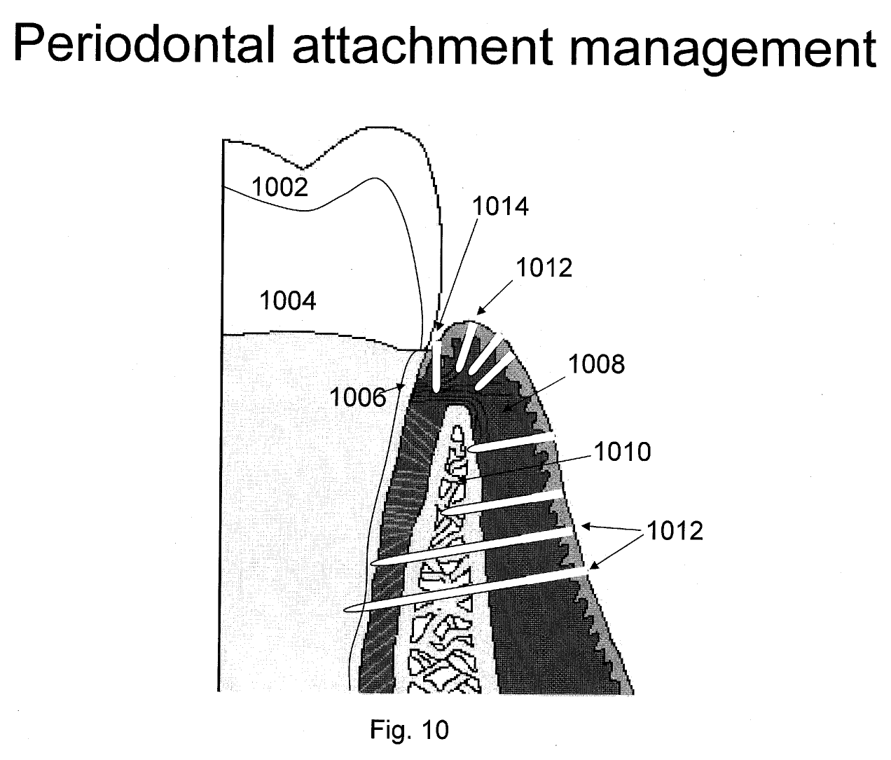

Periodontal regeneration is the regeneration of the tooth supporting structures which have been lost as a consequence of periodontal disease progression. The regeneration includes formation of a new bone and new cementum with a supportive periodontal ligament. Currently, osseous grafting and guided tissue regeneration (GTR) are the two most developed techniques in clinical use. However, only limited histological evidence of true regeneration has been demonstrated by the majority of these therapies. Therefore, additional means to stimulate and direct the tissue regeneration are needed. First of all, a grafting material can serve as a matrix for surface regeneration. Creation of patterned TMZ on the periodontal tissue, including soft tissue, cementum, dentine and bone, can play a positive role in this process. The location of TMZ in the periodontal tissue is shown in FIG. 10. In particular, the creation of TMZ initiates a healing response. A large number of the fibroblasts stimulated by TMZ are present in the tissue for a long period of time, wherein the fibroblasts are instrumental in the process of periodontal attachment. The size of TMZ and the fill factor can be similar to those in the gum recession treatment. The pattern can comprise microcavities created by laser ablation in the bone and the root, inside of which microcavities of the soft tissue will grow. Further, the bone and the boneto-root attachment regenerate as a response to the created pattern of microcavities. Since TMZ can penetrate through the soft and hard tissue, all the tissue can be stimulated for periodontal regeneration simultaneously.

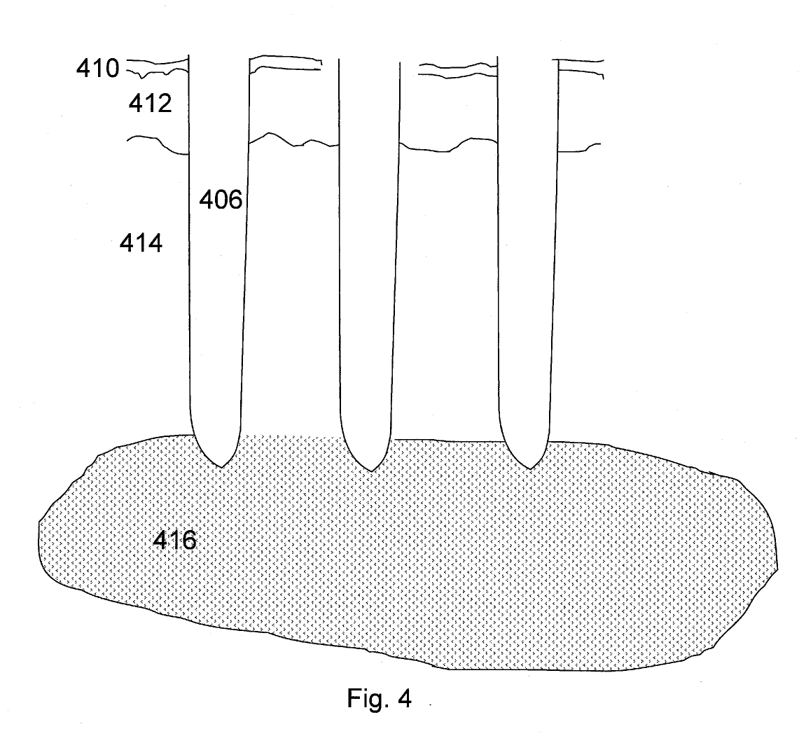

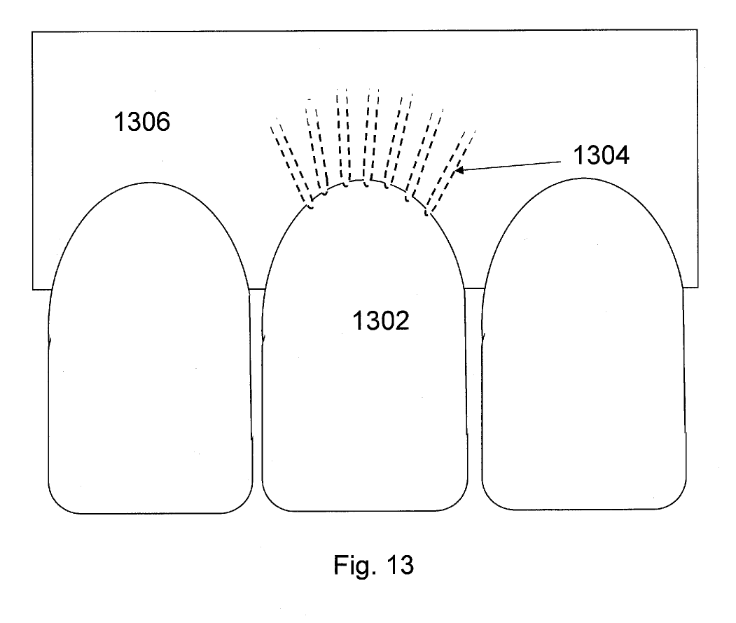

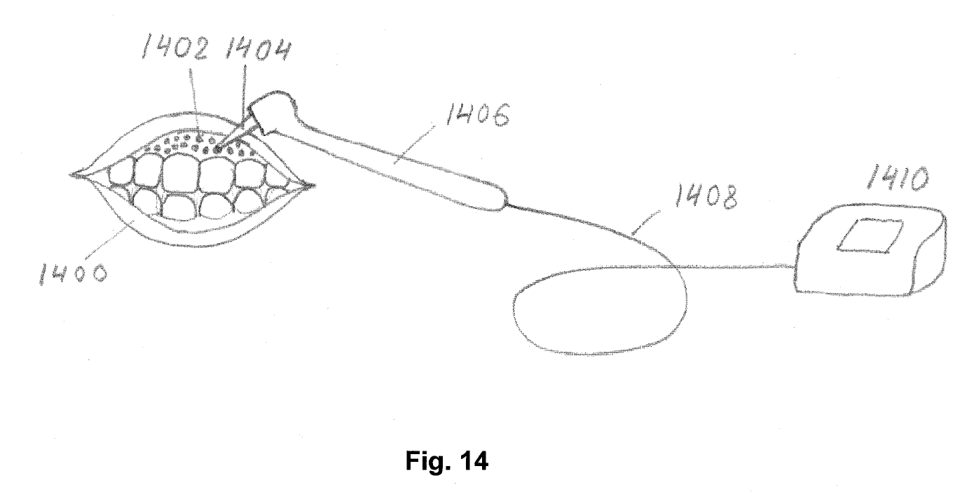

FIG. 4 shows an embodiment where the laser ablation of a TMZ 406 penetrates a gingival stratum corneum 410, an epithelium 412, a connective tissue 414 and where an underlying bone 416 is partially ablated. Other locations of TMZ in the periodontal tissue are shown in FIG. 10. TMZ can penetrate into the gingiva, a periodontal ligament (not shown), cementum, dentine, an alveolar bone. FIG. 10 shows a tooth having an enamel 1002, dentin 1004, cementum 1006 and surrounded by a gingiva 1008 supported by an alveolar bone 1010. The space between the gingiva and the tooth is forms a periodontal pocket 1014. The TMZ 1012 can be made in the gingiva in different areas, including the pocket, and the TMZ can penetrate slightly or deeply into the bone 1010, or even penetrate through the bone and etch the cementum 1006, or penetrate the cementum 1006, as well and make some etching or incision into the dentin 1004. Patterned TMZ in these types of oral tissues can stimulate regeneration of the oral tissues. TMZ 1304 can be located in the periodontal pocket between the gingival 1302 and the root of the tooth 1306, as shown in FIG. 13. During such treatment sterilization of the periodontal pocket can be achieved, for example, due to a steam effect of the vaporized water. The same TMZ can provide the effect of root planning, if the ablative energy sources are used. Due to the shock wave effect during and after the ablation of concrements on the root surface, delaminating of the concrement can propagate from TMZ 1304 to a certain distance. Periodic space Δ between TMZ's 1304 should be equal or smaller than this distance. An Er doped solid state laser with a microbeam diameter of 0.05-0.5 mm, a wavelength of 2700-2950 nm, a pulsewidth of 1 μs to 10 ms and a pulse energy 1-50 mJ can be used to form and ablative column in various tissues. For patterned TMZ treatment just of the soft tissue components in the periodontal area, sterilization and curettage diode laser with wavelength 900-2700 nm, pulsewidth 1 μs to 10 s or CW and power 1-50 W can be used. The regeneration can be enhanced by introduction of additional cellular (such as stem cells), non-cellular (such as extracellular matrix proteins) biomaterial and non-organic material, such as bioactive glasses. All of steps and materials can be combined with laser microtexturing of the tissue surfaces, and facilitate the spatial organization of the cells instrumental to the regeneration process. A similar concept can be used in the gingivitis treatment and in the early stage of periodontitis. This procedure can reduce the frequency of regular professional cleaning procedures for the prevention of gingivitis and aggressive periodontitis. It can also be combined with deep cleaning or curettage.

An important part of implant dentistry is associated with the ability to build osseous tissue around the implant to provide good retention. Laser or mechanical microtexturing of the implant surface can potentially facilitate better attachment of an implant to the implant surface. Laser microetching or microperforation of the bone surrounding the implant stimulates bone regeneration and better attachment to the implant. Also, a bone growth compound is capable of being introduced in the into laser created channel for effective delivery of such a compound into the bone. Also, low level light irradiation can additionally enhance attachment and release of the growth factors.

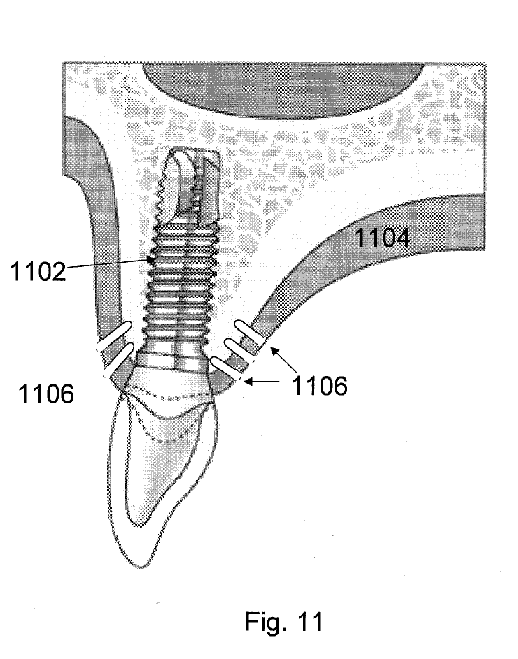

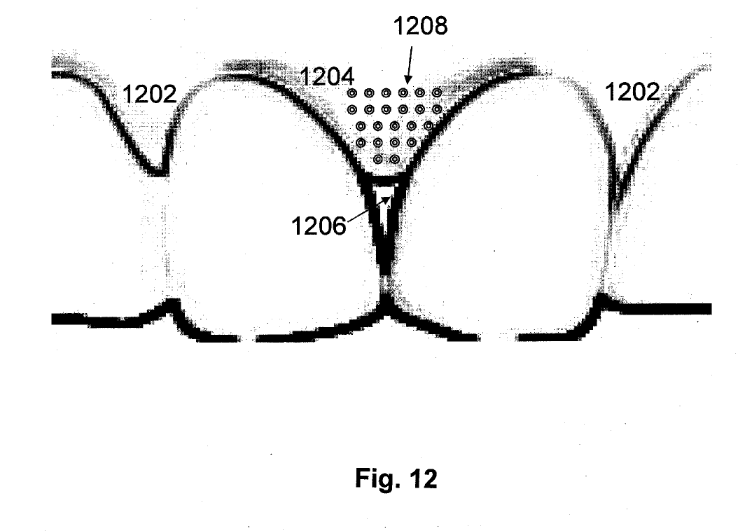

In yet another embodiment, the patterned treatment can be used to stimulate growth or regrowth of the interdental or interimplant papilla. FIG. 11 shows the surface view of the pattern of TMZ 1208. Each TMZ extends to the depth of about 0.7-2 mm into the gingival tissue of the deficient papilla 1204. The papilla 1204 is capable of responding to the TMZ pattern and growing, thus, closing the black triangle 1206 and becoming similar to the normal papilla 1202.

Gingival Recession Around Teeth and Implants

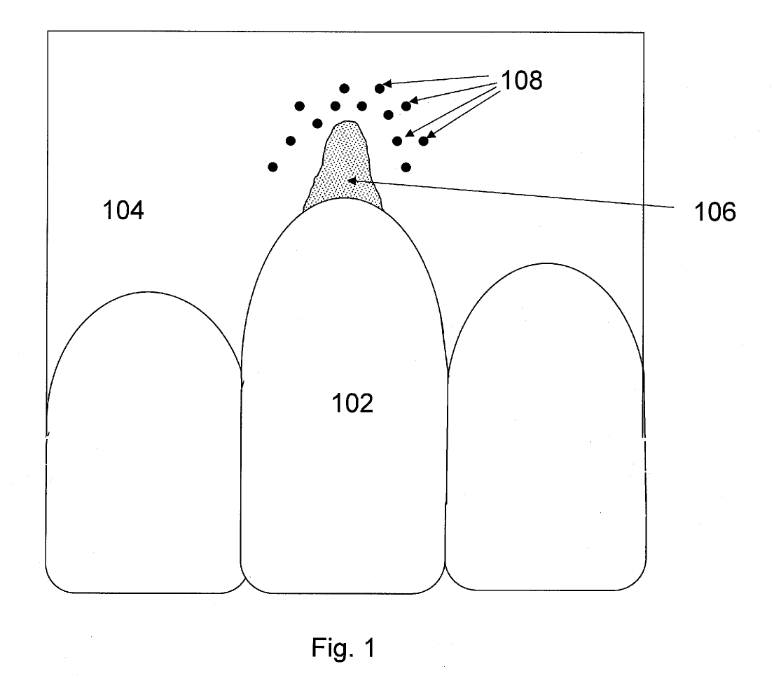

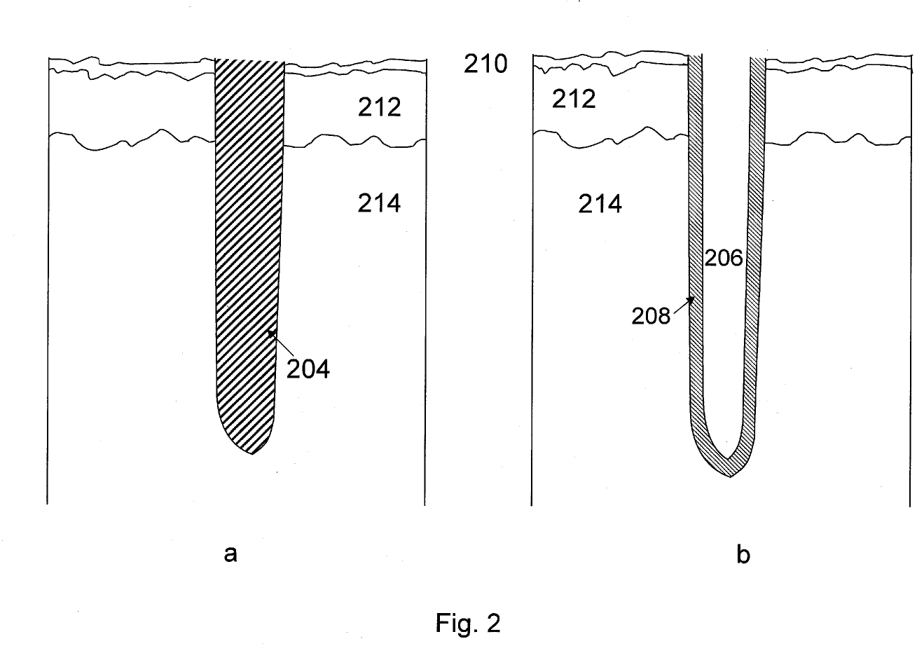

FIG. 1 illustrates one of the preferred embodiments of the invention. A laser with a delivery system (not shown) is used to create a matrix of TMZ 108 in the gingival tissue 104 around the recessed area 106 of the tooth 102. The laser can operate at a wavelength with a high absorption coefficient in the gingiva and create ablative columns in the tissue, or it can operate at a wavelength with a low absorption and create non-ablative (coagulation) columns. The cross-sectional view of each created column is shown on FIG. 2 for non-ablative TMZ having a shape of columns (a) and ablative TMZ columns (b). In non-ablative columns the tissue is not removed, but it is coagulated or otherwise modified within the column (modified tissue shown as 204). In the ablative columns the tissue is removed from the column, creating an empty space microcavity 206 surrounded by a layer of modified tissue 208. In both cases the columns should penetrate corneal layer 210 and epithelium 212 and modify or ablate connective tissue 214. FIGS. 3a and 3b show different possibilities for the TMZ and pattern geometry. FIG. 3a shows non-ablative TMZ and 3b ablative TMZ, respectively. They can have the shape of columns 302 or lines 304 or elongated/oval cavities 306. The TMZ have a smallest size d 310, depth h 312, and pitch Δ 308. The lines (rectangles) also have length l 314. The fill factor of the columns (surface area of modified tissue divided by the total treated area) could be in the range of 0.1% to 75%. The thermal damage of gingiva can initiate tissue regeneration and stimulate vertical growth, or thickness increase or both. The vertical growth can directly be used for the root coverage and recession reduction, while the thickness increase can stop further recession development and can also provide some material to harvest and to provide grafting for root coverage. Also, even partial root coverage for the recessed tooth can reduce dentinal hypersensitivity.

Another application of patterned treatment is a soft tissue recession around implants, which is known to be a significant problem in implantology. A successfully osseointergrated implant can become a failure, if the soft tissue recedes and exposes the implant abutment or other elements. For patients with already existing recession or already loaded implants, the soft tissue can be treated by creating a TMZ pattern in the gingival tissue around the implant to reduce, reverse or prevent recession. For patients with implants to be installed or loaded, the soft tissue can be treated prophylactically, if the tissue biotype suggests an unfavorable prognosis for the recession. After successful healing and strengthening of the gingival tissue, the implant can be loaded/

Improvement of Salivary Glands

A dysfunction of salivary glands can be a major reason for insufficient enamel remineralization and other conditions, such as xerostomia. This dysfunction can be treated by regeneration of salivary gland, stimulated by complete or partial microperforation or microcoagulation of the glands using a laser with parameters described above. Salivary glands include parotid glands, submandibular glands (submaxillary glands) and sublingual glands. In one embodiment of the invention, a pattern of coagulated TMZ can be created, penetrating oral mucosa or gingiva and producing controlled TMZ in the gland to stimulate the gland metabolism and salivary production.

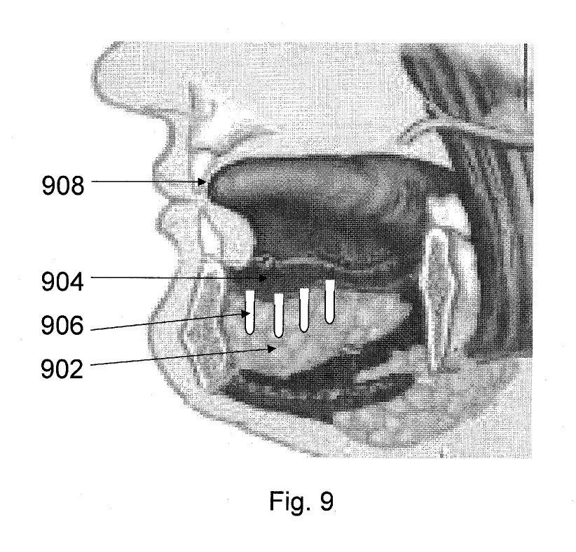

In another embodiment a pattern of ablative or non ablative TMZ can be created in the oral mucosa or gingival, producing superficial treatment of the gland and stimulating its regeneration. The most superficial gland is the sublingual gland and it is therefore more easily accessible to create a TMZ pattern through the oral mucosa. FIG. 9 shows the anatomical location of a sublingual gland 902 and a possible location of the TMZ pattern 906 (in the cross section) penetrating through sublingual oral mucosa 904, located under the tongue 908, into the sublingual gland 902 and stimulating its regeneration.

Lingual Surface Regeneration with Bacterial Reduction.

Bacterial colonies forming on the dorsal lingual surface are a frequent source of halitosis (bad breath). This problem can be treated by using microperforations or microcoagulations produced by a laser with the parameters described above to improve the lingual surface. In one embodiment, a pattern of ablative or non-ablative TMZ created on the dorsal lingual surface promotes lingual tissue regeneration and rejuvenation. Such treatment, in particular, can modify the surface topology to make it smoother and reduce the possibility of retention of bacterial colonies, as well as to make it easier to remove the bacteria during toothbrushing or natural saliva irrigation.

Apparatus for Delivery of Laser Patterned Treatment

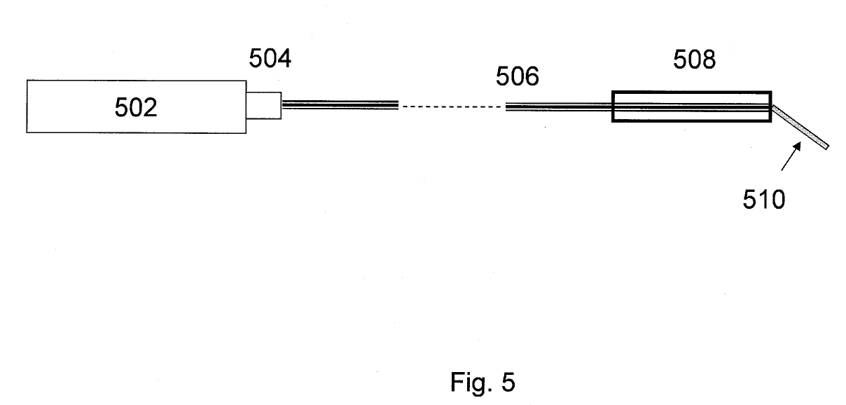

Multiple embodiments can be used to create a device for the delivery of the laser patterned treatment. FIG. 5 shows one preferred embodiment comprising a simple and economical system, where a fiberoptic coupled diode laser 502 is connected to a cable 506 via a fiberoptic connector 504. The light is delivered into a handpiece 508 and is coupled into a tip 510. The tip operates in direct contact with the oral tissue (not shown), providing good optical coupling. The coupling may be further enhanced by applying some pressure to the handpiece. The described embodiment allows to create one TMZ at a time, wherein the tip is manually repositioned to create the pattern of TMZ. This process may be further enhanced and automated as shown in the next embodiments.

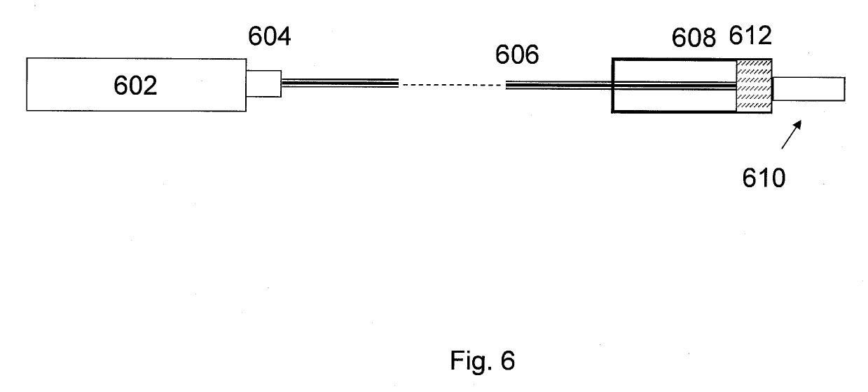

In another embodiment shown in FIG. 6, the light in the handpiece is coupled into a matrix of microlenses 612, which creates a matrix of microbeams at the end of optical applicator 610 and therefore creates a pattern of TMZ during one application of the handpiece.

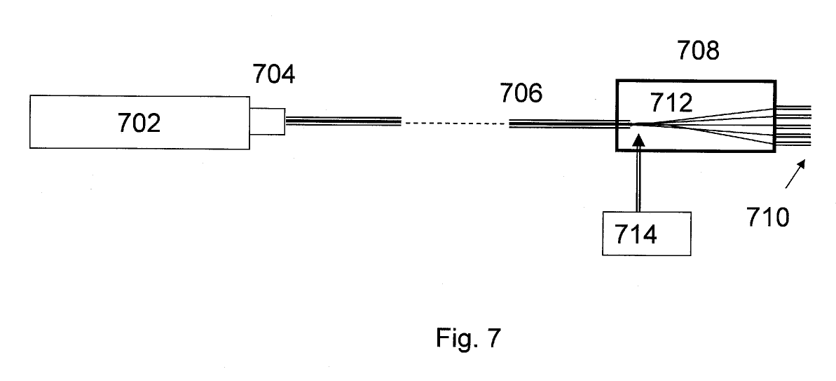

Alternatively, as shown in the FIG. 7, a switchable fiberoptic multiplexer 712 may be user to “scan” optical power between several fibers. In this case, the creation of a single TMZ occurs sequentially; however, it may be done in a short time interval, so for the operator the entire cycle of illuminating all fibers and associate tips will happen momentarily and during one application of the handpiece. The multiplexer is controlled by a control unit 714, which may operate synchronously with the laser if the laser operates in a pulsed mode. Alternatively, a regular scanner (based on a moving mirror or other reflecting or deflecting element, or based on a fiber tip movement) may be used to produce a TMZ pattern as well.

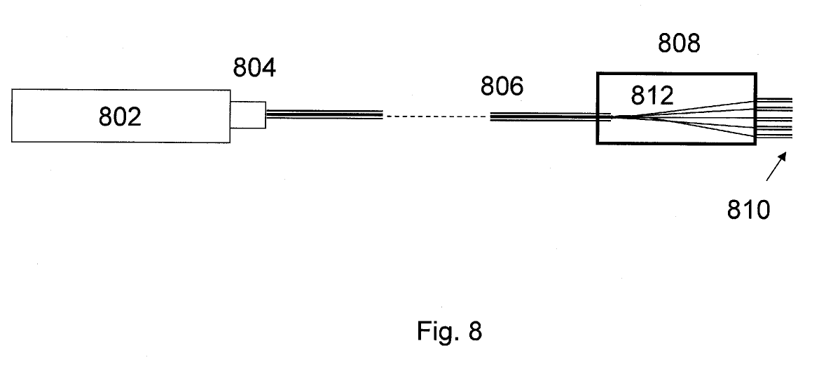

If the optical power or pulse energy is sufficient to create several TMZ simultaneously, then yet another embodiment shown at FIG. 8 can be used. In this embodiment a 1×N fiberoptic splitter 812 is used to channel the energy into multiple tips 810 for simultaneous creation of the TMZ pattern.

In another group of embodiments a solid state laser (preferably diode pumped) located in a handpiece is used to deliver high-brightness, ablative radiation in the pulsed regime. In one preferred embodiment, it could be an Er doped YLF or YAG or YSGG laser operating in the 2700-3000 nm spectral range, with the pulse energy of 1-100 mJ, pulse duration 1-1000 μs, repetition rate 1-500 Hz. The laser can operate in a contact or non-contact mode. In one embodiment, the laser creates one TMZ per handpiece application and has to be repositioned to create another TMZ. In another embodiment, the laser is combined with a beam scanner, creating an TMZ pattern in one application of the handpiece. The scanner can cover an area from 1×1 mm to 10×10 mm and the pattern creation cycle can take from 0.1 second to 10 seconds.

Different systems of feedback (not shown) may be used to enhance the treatment process or outcome. A feedback based on reflection of a low power pilot radiation can detect an optical contact between the tip and the tissue for automated laser firing. During the TMZ irradiation, a real time feedback based on change of optical scattering or reflection from the tissue, hot tissue or hot tip radiation, change in acoustic or electrical impedance properties, fluorescence etc. can be used to modify the parameters of the energy delivered to the TMZ and to stop the energy application as some predetermined TMZ parameters (depth, volume, temperature, level of coagulation, level of photodye bleach etc.) are reached.

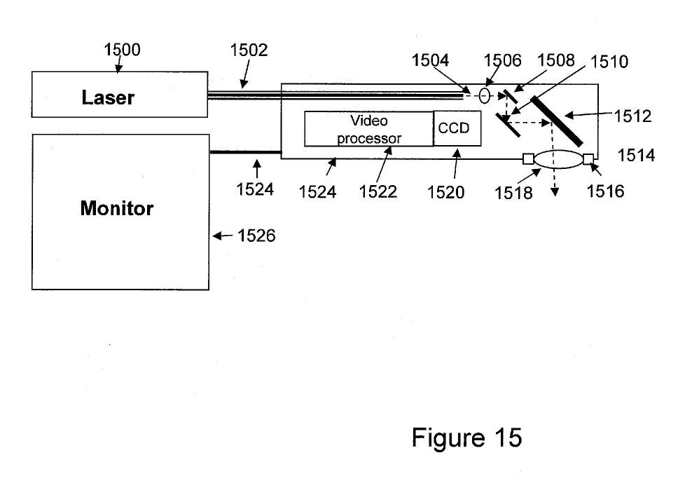

In another embodiment the device for patterned TMZ therapy can be integrated with a dental camera, as shown on FIG. 15. The integration allows for a good visualization of the treatment area using a CCD sensor 1520, a video processor 1522 and a monitor 1526, as well as for programming the location of the patterned TMZ on the tissue. Using a laser 1500 with a delivery optical fiber 1502, collimated optics 1506 and scanners 1508 and 1510, a treatment laser beam 1504 is delivered through a mirror 1512 and an objective 1518 to the treatment area combined with the observation area and illuminated by a light sources 1516. Components 1502 to 1522 are packaged into a dental camera/treatment handpiece housing 1524 and are electrically connected to a main unit 1526 with monitor. In this embodiment it is possible to perform programming of the positioning of patterned TMZ on the treatment area on the screen using the image of treatment area captured by the dental camera.

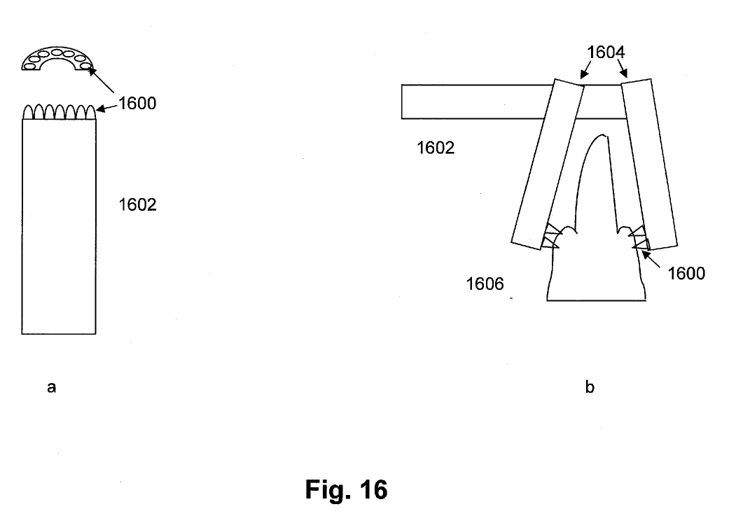

An applicator for the treatment oral anatomical area with a predetermined shape can be used for the delivery of the TMZ pattern. The treatment applicator for delivering the energy to the tissue can be designed to be adapted to the complex geometry of different parts of the oral cavity to simplify treatment and to deliver consistently patterned TMZ. FIG. 16 shows two examples of the applicators adapted to the jaw treatment. Elements 1602 and 1604 are the components of the delivery system for transferring treatment energy from a handpiece (not shown) to microtips 1600, which are designed to couple the energy into the TMZ. FIG. 16a shows an applicator for treatment of the arc-shaped gingiva. FIG. 16 shows an applicator for simultaneous treatment of the front side and the back side of periodontal area of tooth. Delivery components 1604 can be adjusted to individual size of periodontal unit 1606. Such applicator can be made disposable to avoid multiple sterilizations.

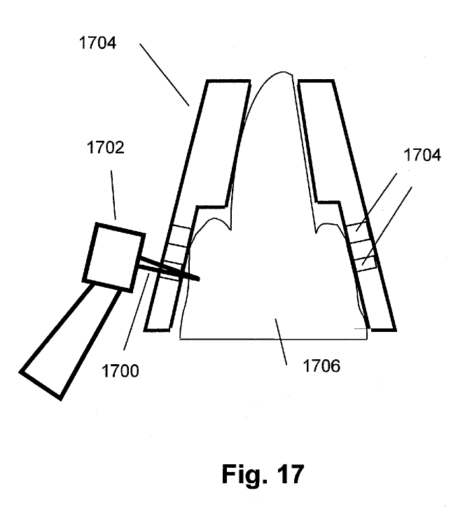

A fixture for treatment oral anatomical area with predetermined shape can be used for delivery TMZ pattern. FIG. 17 shows fixture 1704 conforming to at least one anatomical feature as periodontal unit of the tooth 1706. Fixture 1706 has holes 1704 for positioning tip 1700 of handpiece 1702 for delivering energy in TMZ on the treatment area of periodontal unit 1706. Holes geometry on fixture 1704 generates patterns geometry of TMZ. Fixture 1704 can be design to adopt typical anatomical area or can be prepared individually using technique similar to impression making. Such fixture can be made disposable to avoid multiple sterilizations.

While this invention has been particularly shown and described with references to preferred embodiments thereof, it will be understood by those skilled in the art that various changes in form and details may be made therein without departing from the scope of the invention encompassed by the appended claims.

1. A method comprising the steps of:
creating a predetermined pattern of treatment microzones in oral tissue affected by a condition by applying energy of predetermined characteristics to the oral tissue through at least one tip, the at least one tip having a size and shape being limited by a characteristic of a treatment area in an oral cavity, the oral tissue being located in the oral cavity; and
terminating the application of energy to the oral tissue after creating the predetermined pattern of treatment microzones in oral tissue,
wherein a type of the energy and the characteristics of the predetermined pattern of treatment microzones are defined by the condition in the oral tissue and a type of the oral tissue.

2. The method of claim 1, wherein applying the energy of the predetermined characteristics comprises applying electromagnetic radiation, thermal energy in a form of thermal conduction, AC or DC electrical current, ultrasonic energy, mechanical action, chemical action and combinations thereof.

3. The method of claim 1, wherein creating the predetermined pattern of treatment microzones in the oral tissue affected by a condition comprises creating the predetermined pattern of treatment microzones in the form of a column, sphere, semisphere, line, rectangular or a shape of hypo or hyperthermia, coagulation, microcavity, chemical alteration or ablation with a depth ranging from 0.05 to 10 mm, a minimal size, being a diameter or a width, from 0.005 to 1 mm, and having a fill factor from 0.1% to 75% per one treatment.

4. The method of claim 1, wherein the oral tissue is oral soft tissue.

5. The method of claim 1, wherein the oral tissue is oral hard tissue.

6-8. (canceled)

9. The method of claim 2,
wherein the electromagnetic energy is optical energy, and
wherein the characteristics of the optical energy are a wavelength selected from a range from 290 to 11,000 nm, energy range per a treatment microzone selected from a range from about 1 μl to about 10 J, fluence is selected from a range from about 0.01 J/cm2 to about 1 kJ/cm2.

10. The method according to claim 4, wherein the oral soft tissue is oral mucosa soft tissue or a gingival soft tissue or a gland.

11. The method according to 5, wherein the oral hard tissue is a bone, dentine, cementum, or cartilage.

12-22. (canceled)

23. A regeneration method comprising the steps of:
creating a predetermined pattern of treatment microzones in oral-tissue subjected to regeneration by applying energy of predetermined characteristics to the oral tissue through at least one tip, the at least one tip having a size and shape being limited by a characteristic of a treatment area in an oral cavity, the oral tissue being located in the oral cavity; and
terminating the application of energy to the oral tissue after creating the predetermined pattern of treatment microzones in the oral tissue,
wherein a type of the energy and the characteristics of the predetermined pattern of treatment microzones are defined by a type of regeneration and a type of the oral tissue.

24. The method of claim 23, wherein applying the energy of the predetermined characteristics comprises applying electromagnetic radiation, thermal energy in a form of thermal conduction, AC or DC electrical current, ultrasonic energy, mechanical action, chemical action and combinations thereof.

25-28. (canceled)

29. The method of claim 23, wherein creating the predetermined pattern of treatment microzones in the oral soft tissue subjected to regeneration comprises creating the predetermined pattern of treatment microzones in the form of a column, sphere, semisphere, line, rectangular or a shape of or hyperthermia, coagulation, microcavity, chemical alteration or ablation with a depth ranging from 0.05 to 10 mm, a minimal size, being a diameter or a width, from 0.005 to 1 mm, and having a fill factor from 0.1% to 75% per one treatment.

30-41. (canceled)

42. A device for acting on oral tissue comprising:
a source for generating energy for treatment of oral tissue;
a delivery system for delivering energy to the oral tissue subjected to treatment to create a predetermined pattern of treatment microzones in the oral tissue, the delivery system comprising a tip serving to create the predetermined pattern, the at least one tip having a size and shape being limited by a characteristic of a treatment area in an oral cavity, the oral tissue being located in the oral cavity.

43. The device of claim 42, wherein the energy is selected from the group consisting of electromagnetic radiation, thermal energy in a form of thermal conduction, AC or DC electrical current, ultrasonic energy, mechanical action, chemical action and combinations thereof.

44. The device of claim 42, wherein the at least one tip serves to deliver the energy to the treatment microzones formed as a column, sphere, semisphere, line, rectangular or a shape of hypo or hyperthermia, coagulation, microcavity, chemical alteration or ablation with a depth ranging from 0.05 to 10 mm, a minimal size, being a diameter or a width, from 0.005 to 1 mm, and having a fill factor from 0.1% to 75% per one treatment.

45. The device according to claim 43 wherein the electromagnetic energy source is an optical source.

46. The device of claim 45, wherein optical parameters of the optical source are a wavelength selected from a range from 290 to 11,000 nm, energy range per a treatment microzone selected from a range from about 1 μl to about 10 J, fluence is selected from a range from about 0.01 J/cm2 to about 1 kJ/cm2.

47. The device of claim 42, wherein the oral tissue is oral soft tissue.

48. The device of claim 42, wherein the oral tissue is oral hard tissue.

49. The device of claim 42, wherein the oral tissue is a combination of oral hard tissue and oral soft tissue.

50-64. (canceled)
